(19) United States
(12) Patent Application Publication
(10) Pub. No.: US 2016/0366843 A1
(43) Pub. Date: Dec. 22, 2016

(54) LIQUID IRRIGATION SYSTEM

(71) Applicant: George Evans, Leeds (GB)

(72) Inventor: George Evans, Leeds (GB)

(21) Appl. No.: 15/233,265

(22) Filed: Aug. 10, 2016

Related U.S. Application Data
(63) Continuation-in-part of application No. 12/997,381, filed on Dec. 10, 2010.

(30) Foreign Application Priority Data
May 6, 2008 (GB) 0808164.8
Aug. 19, 2008 (GB) 0815092.2
Mar. 10, 2009 (GB) 0904119.5

(51) Int. Cl. A01G 27/00; A01G 31/02

(52) U.S. Cl. CPC A01G 27/003; A01G 31/02; A01G 27/005; A01G 27/008; A01G 27/001

(57) ABSTRACT

The present invention provides a liquid application system for plants and the like, the system including a power supply, controller, supply system and a tube member. The tube member is placeable into or connectable to a liquid reservoir to allow liquid from the reservoir to be supplied therefrom to plants and the like. Additionally, a liquid application system is provided having a reservoir in which liquid can be collected, a body of matter in which at least one plant can be planted to grow and a supply system to allow liquid to be selectively removed from the reservoir to be applied to the body of matter, the application of liquid occurring with respect to the condition of a power supply connected to at least the supply system. The system further includes flow rate limiter, for restricting the flow of liquid through the system and into the body of matter.

### BACKGROUND

The invention to which this application relates is to an improved irrigation system which allows the controlled application of liquid such as water or hydroponic solution to a body of matter such as soil or other plant growing medium so as to reduce the risk of plants in said body of liquid being damaged or dying in dry or drought conditions.

It is well known that liquid is required to be added to the matter in which plants are growing, particularly during hot or prolonged dry parts of the year in order for the plants to survive and/or grow to their full potential. The application of liquid can be performed via the relatively simple process of applying liquid from a hose or watering can or by using relatively complex irrigation systems. It is also known, in times of liquid shortage, to use rainwater, rather than water from a mains supply, with the rain water being collected in butts from which the same can be applied or, alternatively, can be supplied via piping to the area of application.

At worst, the application of the liquid can be random and relatively haphazard or there may be relatively complex timing systems employed to ensure that liquid is applied by irrigation systems for a period of time. However, these timing systems typically apply liquid regardless of prevailing weather conditions and therefore on occasion, the plants may be overwatered or on other occasions, under watered. It is also found that the provision of these watering systems with control systems become relatively expensive to install and therefore typically only used by professional or keen amateur gardeners.

It is also known to provide watering systems suitable for “vertical gardens” and the like, that is to say, where liquid is to be applied to matter at varying heights. Such systems may include “drippers”, which are provided to restrict the flow rate of the liquid and allow the build-up of pressure, such that the liquid will extend through the system and reach all the drippers provided at varying heights. Currently available dripper systems are too fast to allow an appropriate build-up of the pressure and are prone to becoming blocked. When drippers are being used at different heights and once the flow of liquid ceases, that liquid tends to recede away from the highest drippers and back down the pipeline system to the lower positions. When the flow of liquid is activated once more, it takes substantial time for the liquid to reach the higher drippers in order to be dispersed, all the while the liquid is already being dispersed from the lower-placed drippers. This leads to either an under-watering at higher positions, or an over-watering of the material at lower positions in order to obtain adequate watering at the higher levels, which is clearly unsatisfactory.

### SUMMARY

The aim of the present invention is to provide a system which allows improved utilization of liquid and, furthermore, allows the liquid to be applied in a more efficient and controlled manner with respect to when the liquid is actually required by the plants with regard to the environmental conditions.

In a first aspect of the invention, there is provided a liquid application system, said liquid application system including a reservoir in which liquid can be collected, a body of matter in which at least one plant can be planted to grow and a supply system to allow liquid to be selectively removed from the reservoir to be applied to the body of matter and wherein the application of liquid occurs with respect to the condition of a power supply connected to at least the supply system.

In one embodiment the application of liquid occurs with reference to the condition of the power supply, said power supply charged by use of at least one component of the environment. In one embodiment the component is any or any combination of wind and/or light.

Typically a number of plants will be planted in the body of matter.

In one embodiment, the supply system includes at least one pump provided to pump liquid from the reservoir onto the body of matter. In another embodiment, the supply system may be provided as the natural flow of liquid from a mains-connected tap.

In one embodiment, the power source comprises one or more rechargeable batteries. In one embodiment mains or non rechargeable batteries may also be provided or provided as an alternative to rechargeable batteries.

In one embodiment therefore the operation of the pump and hence supply of liquid is dependent on there being sufficient charge in the batteries at any given time so as to operate the pump.

In one embodiment a controller is provided alternatively to, or in addition to, the power supply, said controller influencing or allowing complete control of the condition of the power supply in terms of switching the same on or off and/or controlling the condition of the power supply in terms of time of operation and/or level of charge provided to operate the system.

In one embodiment, where rechargeable batteries are provided, the same can be charged using a natural resource such as wind, solar energy or the like, but, preferably, utilises solar energy via one or more solar panels connected to the power source. An advantage of using solar power is that, firstly, the same is an effective means of charging the power sources and also, generally, when the panels are being charged by solar power so, at the same time, the general and environmental conditions will be dry as the sun is shining. This therefore means that it is likely that the watering of the body of soil will be required due to the dry and/or hot environmental conditions. Thus, as the shining of the sun represents the opportunity for the solar panels to be charged so there is provided a proportional link between the available power to apply the liquid and the requirement for the liquid to be applied.

In one embodiment, the reservoir of liquid is located underneath the body of matter and is separated therefrom by a permeable membrane which allows excess liquid which falls onto the matter by application via the system, and/or precipitation, to pass through the matter and membrane and into the reservoir to be stored therein for subsequent use.

In one embodiment, the reservoir incorporates a liquid permeable substance such as perlite, an aggregate holding liquid in the interstices or, alternatively, only liquid is held within the reservoir.

Typically, at least one reservoir tube is provided in the reservoir and via which liquid can leave the reservoir to be pumped onto the body of the matter.

In one embodiment, there is provided pump mounted with a connecting tube member, which is received by the reservoir tube so as to allow liquid to be pumped from the reservoir via the pump and then applied to the body of matter. Typically the pump is mounted towards the entry at the lowest part of the connecting tube member and, therefore, sits within the liquid of the reservoir and is therefore self priming. Alternatively, positive displacement pump can be used which need not be positioned at the entry to the pump connecting tube.

In one embodiment, the application of the liquid from the pump to the body of matter is via an irrigation system.

Typically, control circuitry, switch devices and at least one solar panel, along with the power sources, are located on the pump connecting tube and in or on a housing provided on said pump connecting tube.

In one embodiment, there is provided at least one means by which liquid held within the reservoir can be taken from the reservoir separately.

In one embodiment, the body of matter and the reservoir are located such as to form a raised bed.

In one embodiment the raised bed can receive thereon, further components such as for example a cloche comprising a series of spaced support members which support a sheet material therebetween. Preferably, the sheet material is located with regard to the raised bed such that any precipitation which falls on the sheet material, slides down the same and into the soil into the raised bed thereby passing towards the reservoir.

Preferably, the pump connecting tube, pump and housing can be selectively located onto a reservoir tube of any of a range of reservoirs. This therefore means that there may be a number of reservoirs with a number of reservoir tubes connected thereto but only one or a lesser number of pump connecting tubes, pumps and housing need to be provided thereby allowing the user to selectively position the pump connecting tube in the location where it is most required at any given time and still ensure that watering can be achieved. This also ensures that the system can be more economical to buy as the most expensive part typically will be the pump tube. The provision of solar power to allow the pump to be operated means that the same can be positioned anywhere and need not be close to a mains electricity supply.

In a further aspect of the invention, there is provided a liquid application system for plants and the like, said system comprising a power supply, a controller, a supply system and a tube member, wherein said tube member is placeable into or connectable to a liquid reservoir to allow liquid from the reservoir to be supplied therefrom to said plants and the like.

In one embodiment, the supply system includes at least one pump provided to pump liquid from the reservoir onto the body of matter. In another embodiment, the supply system may be provided as the natural flow of liquid from a mains-connected tap or the like.

In one embodiment, said liquid reservoir may be provided as a mains-connected water supply, or as a liquid-containing member in which the said liquid may be collected.

In one embodiment the power supply is any or any combination of a mains power source, or a solar panel or a windmill provided to charge one or more rechargeable batteries.

Typically the controller, power source and pump are provided as an integral unit, along with, if provided, one or more solar panels. In another embodiment, the pump is provided separately from the controller and power source. Typically, said pump can be attachable to or in communication with the said controller and/or the power source.

In one embodiment, the pump is a submersible pump.

In one embodiment, the reservoir tube and/or pump connecting tube includes a filter device so as to minimise the particles which pass through the same and which may otherwise cause blockage of the pump or irrigation system supplied thereby.

In one embodiment, the system further includes a solenoid valve, provided in communication with said controller and/or power source. Typically, said solenoid valve is located at an interface or connection between said controller and supply system, and is provided so as to permit or prohibit the flow of liquid through the reservoir tube and/or pump connecting tube.

Typically, the supply system is provided as the natural flow of liquid from a mains-connected tap or the like and the solenoid valve is provided so as to permit or prohibit the flow of liquid therethrough.

In one embodiment, the controller control operation of the solenoid. Typically, rather than switching an integrally connected pump on and off, the controller may instead control the operation of the solenoid between open and closed positions, thereby allowing the supply of liquid for an irrigation system.

In one embodiment, moving the solenoid valve to an open position permits the flow of liquid from the reservoir to the body of matter and/or an irrigation system. Typically, moving the solenoid to a closed position prohibits such a flow of liquid.

In one embodiment, one or more sensors are provided in communication with said controller. Typically, said one or more sensors are provided to detect a change in one or more conditions associated with the system or the surrounding environment.

In one embodiment, said one or more sensors may be provided to detect a change in condition of any or any combination of the following: water level of the reservoir; moisture content of the body of matter; and/or levels of sunlight available. Typically, the detection of such conditions or changes in such conditions can be relayed to the controller. Further typically, and based on the detection of such conditions or changes in such conditions, the controller can activate or deactivate the said pump and/or solenoid valve, thereby permitting or prohibiting the flow of liquid.

Thus, by providing one or more sensors in association with the controller, this therefore allows operation of either the pump or solenoid valve and, consequently, the flow of liquid to the body of matter, to be determined by a change in condition of any or any combination of a number of variables. This is highly advantageous as it allows the system to respond as is required, as opposed to being restricted to operation based on a rudimentary timer system.

In one embodiment, a water level sensor is provided in communication with said controller. Typically, said water level sensor is located within the reservoir. Typically, if the level of liquid within the reservoir falls below a predetermined level, a signal is sent to the controller to switch off the pump and/or close the solenoid valve, thereby preventing any further flow of water. In one embodiment, the position of the water level sensor is adjustable within the reservoir. Typically, the level of liquid within the reservoir below which a signal is sent can be determined and adjusted by a user.

In one embodiment, if the level of liquid within the reservoir falls below a predetermined level, a notification system is provided associated with the water level sensor. Typically, said notification system may be provided as a device or devices providing any or any combination of: an audible notification; a visual notification; and/or a data notification sent to an associated mobile device.

In one embodiment, a moisture sensor may be provided in communication with said controller. Typically, said moisture sensor is provided to measure the moisture content of the body of matter. In one embodiment, if the moisture content of the body of matter falls below a predetermined level, a signal is sent to the controller to switch on the pump and/or open the solenoid valve, thereby permitting the flow of liquid to the body of matter. Typically, the threshold level of moisture content can be predetermined by a user. Further typically, when the moisture content of the body of matter reaches or exceeds another predetermined level, a signal is sent to the controller to switch off the pump and/or close the solenoid valve, thereby preventing the flow of liquid to the body of matter.

In one embodiment, a light sensor may be provided in communication with said controller. Typically, said light sensor is provided to detect the level of sunlight to which it is being exposed. In one embodiment, if the light levels rise above a predetermined level, a signal is sent to the controller to switch on the pump and/or open the solenoid valve, thereby permitting the flow of liquid to the body of matter. Typically, the threshold level of light can be predetermined by a user. Thus, in this particular arrangement, the system can be programmed to activate and supply water during hours where sunlight is at its strongest, ensuring the plants, flowers, etc. do not dry out.

In another embodiment, if the light levels drop below a predetermined level, a signal is sent to the controller to switch on the pump and/or open the solenoid valve, thereby permitting the flow of liquid to the body of matter. Thus, in this embodiment, the system may also be programmed to activate during, for example, night time hours, such that the plants, flowers etc. are watered and/or fed overnight.

In one embodiment, said power supply may be provided, at least in part, by the provision of one or more solar panels. Typically, said one or more solar panels are provided in communication with said controller.

In one embodiment, said one or more solar panels are used to charge one or more batteries which, in turn, supply electrical power to the controller and/or supply system.

In a further aspect of the system there is provided a liquid application system, said system including a reservoir for the collection of liquid to be dispersed to provide a watering effect, supply system connected to move liquid from the reservoir via a pipe and wherein the system further includes a power supply and a controller to control the system such as to control the application of the liquid.

In one embodiment the pipe includes at least one sensor mounted therein, the condition of the sensor varying dependent upon whether the same is in contact with the liquid at that instant.

Typically the sensor detects a current which is monitored by controller and the level of the current is indicative of whether or not the sensor is in the liquid. This, in turn, allows the control of the switching on and off of the pump and hence the liquid supply to the liquid application system.

In one embodiment a plurality of sensors are provided, said sensors provided at spaced locations on the downpipe.

In one embodiment the sensor can be used to detect a condition of the liquid. In one embodiment the detection is the presence or otherwise of a constituent of the liquid, such as, for example, the fertilizer content. This indication can be used to generate an indication of the condition to the user and the user can react to the same accordingly and alter the condition of the liquid as appropriate.

In one embodiment one or more solar panels are used to charge one or more batteries which, in turn, supply electrical power to controller and/or supply system.

In one embodiment a controller, such as a potentiometer, is provided to control the amount of solar power supplied to the batteries, and hence power to the supply system, either in the form of a pump or a solenoid valve, so as to allow the control of the operation of the same.

In one embodiment the controller is adjustable by the user between a maximum in which all solar power is used to charge the batteries and hence power the supply system, and a minimum in which only part of the possible battery charge is used, thereby limiting the usage of the pump, or activation of the solenoid valve and hence the watering effect. This, in turn, allows direct control of the operation of the supply system and the extent of watering which occurs. It also allows the system to be more adaptable, for example, the control of the supply system allows the system to be capable of being used either in water butts or when connected to a mains supply of water. In one embodiment the supply system is turned on by a timer, and turned off by the monitored voltage dropping to a predetermined level.

In one embodiment when the system is used in certain apparatus, such as, for example, in water butts, an anti-siphoning device is fitted for the pump in order to allow the same to operate effectively.

In an aspect of the present invention, there is provided a liquid application system, said system including a power supply in the form of one or more solar panels, controller, liquid supply system, and a tube member placeable into or connectable to a liquid reservoir to allow liquid from the reservoir to be supplied therefrom, and wherein said one or more solar panels are used to charge one or more batteries which, in turn, supply electrical power to the controller and/or supply system, the activation of which are thus determined by the degree of charge provided by the one or more solar panels.

Thus, the present invention provides a liquid application system that has its own power supply, and which can be used to determine the periods at which the controller and/or supply system are activated to supply the flow of liquid to a body of matter. The presence of increased sunlight consequently provides more charge to the one or more solar panels, which will most likely coincide with time when the conditions are at their driest and/or hottest, and when the plants and the like will require watering. With the one or more solar panels subsequently providing the required charge, the system can then permit the supply of water as required, and may be further determined by one or more additional sensors, as discussed above. Importantly, where periods of low or no sunlight occur, the one or more solar panels do not supply as much, if any charge to the batteries. Thus, such a decrease in charge can be used as an override, in particular where further “downstream” sensors are provided, to restrict the supply of liquid, which will usually coincide with periods where watering is not required so much, for example, overnight or during cloudy and rainy periods. Electrical charge built up by the solar panels may be stored in the batteries such that the system may still be used in times of low or no light, but such circumstance may be predetermined by a user (for example, if overnight watering is desired). The system of the present invention therefore provides a clear advantage over those systems whereby a rudimentary timer system is required to determine when the supply system and/or controller and, hence, the flow of liquid, may be activated.

In a further aspect of the invention there is provided apparatus for moving a liquid from a liquid reservoir to be dispersed on and/or into a body of matter, said apparatus including a portion, at least part of which is positioned in communication with the body of liquid in said reservoir, a pump operable to draw liquid from the reservoir via the said portion to a dispersal system and a controller to control the operation of the pump.

Typically said portion defines a passage along which the liquid passes to the dispersal system.

In one embodiment the pump acts to move the liquid to and through the dispersal system. The dispersal system can in one embodiment be an irrigation system.

In one embodiment, the controller, a power source and the pump are located within a common housing.

In one embodiment the power source includes at least one solar panel mounted externally of the housing and batteries, at least partially charged by the solar panel, mounted within the housing.

In a further aspect of the invention there is provided apparatus for moving liquid from a reservoir to be selectively dispensed onto a body of matter, wherein the apparatus is operable such that the amount of liquid which is dispensed is proportional to the condition of at least one component of the environment in the vicinity of the apparatus.

In one embodiment the environmental component is the amount of sunshine and/or predefined light conditions to which at least part of the apparatus is exposed.

In one embodiment the part of the apparatus which is exposed to the sunlight and/or predefined light conditions (hereinafter referred to as sunlight in a non-limiting manner) includes at least one solar panel thereon and this, in one embodiment, is provided as an integral part of the assembly or can be selectively detached therefrom so as to be positioned in improved light conditions with respect to the location of use of the remainder of the assembly.

In one embodiment, the more sunshine or more light to which the said part is exposed then the more liquid is dispersed by the system which is what would normally be desired as the greater amount of sunlight then the greater the drying effect on the body of matter onto which the liquid is to be dispensed and hence the greater the need for liquid.

In one embodiment the proportional link between sunlight and operation of the apparatus can be adjusted by the user to suit specific requirements, such as the type of plants grown in the body of matter at that time.

In one preferred embodiment of the invention, all the main components are contained within a single integrated housing to facilitate ease of set-up and use, and includes a solar panel integrated and linked to charge rechargeable batteries.

In one embodiment, in operation, when there is sufficient charge in the batteries, the pump is started up and continues to run until the battery voltage drops to a predetermined level.

The more sunshine there has been, the longer this will take and hence the longer period of operation of the pump.

As a result the watering effect is proportional to sunshine, as the operation of the pump to displace the liquid from the reservoir to the dispersal system is required using controller and indicator on the housing. Also, via the controller, the user can adjust the length of time of operation of the pump and/ or the proportion of sunshine which is collected and used to charge the batteries. Typically, there are four levels of user selectable operation and an off setting. For example, at the highest setting, on a bright day, the pump will run about one third of the time. At the lowest setting this drops to about 2% of the time. Whichever setting is used, the amount of watering still remains proportional to sunshine but the user is able to adjust output according to their requirements.

It should also be appreciated that reference herein to sunshine can also mean light conditions which are sufficiently bright (even though the sun may not be exposed) so as to enable the solar panel to operate to charge the batteries.

In another aspect of the invention, there is provided a liquid application system, said liquid application system including a reservoir in which liquid can be collected, a body of matter in which at least one plant can be planted to grow and supply system to allow liquid to be selectively removed from the reservoir to be applied to the body of matter, the application of liquid occurring with respect to the condition of a power supply connected to at least the supply system, and wherein the system further includes flow rate limiter, for restricting the flow of liquid through the system and into the body of matter.

In one embodiment, said flow rate limiter may be connectable to, or formed integrally with, a tube member associated with the said supply system. Typically, at least some of the liquid is supplied through the system to the body of matter via the flow rate limiter.

In one embodiment, said flow rate limiter includes: a chamber having an inlet portion; an outlet portion; and a flow restrictor provided across an interface between said inlet portion and the chamber.

In one embodiment, said inlet portion includes a connecting member for connection with a tube member associated with the said supply system. Typically, said connecting member is provided as a T-shaped junction, thereby allowing liquid to flow both into the inlet portion and to continue through said tube member.

In one embodiment, said flow restrictor comprises a blocking member, located at the interface between said inlet portion and said chamber, and movable between open and closed positions; and a biasing member, biasing said blocking member to a closed position. Typically, said blocking member is formed from an impermeable material. Further typically, said biasing member is formed from a permeable material. Preferably, said biasing member is formed from a resilient, permeable membrane, which biases the blocking member to the closed position.

In one embodiment, said chamber comprises an inlet chamber and an outlet chamber. Typically, said flow restrictor, comprising a blocking member and a biasing member, forms a partition between said inlet chamber and said outlet chamber.

In one embodiment, upon build-up of liquid pressure through the inlet portion and at the interface, said blocking member is movable to an open position, thereby allowing the flow of liquid into the inlet chamber. Typically, liquid is provided to permeate through the said membrane from the inlet chamber into the outlet chamber and, consequently, out of the outlet of the flow rate limiter and into the body of matter.

In one embodiment, upon a reduction of liquid pressure at the interface, said blocking member is movable to the closed position, thereby preventing the flow of liquid and/or gas from the outlet chamber through the inlet portion. Thus, as the flow of liquid from the supply system is reduced or stopped, the flow rate limiter acts so as to prevent the return of liquid therefrom and back into the tube members. Such a feature is most advantageous in embodiments where one or more flow rate limiter are provided and at varying heights; those at greater heights or a greater distance from the supply system will not now suffer from liquid receding back through the tube members, as discussed above, and there will, consequently, be no delay in applying liquid to the body of matter when the supply of liquid is switched back on.

In one embodiment, said flow restrictor act as a one way valve, allowing liquid into the inlet chamber and, consequently, the outlet chamber, via the inlet portion, but preventing reverse movement of the same.

In another aspect of the present invention, there is provided flow rate limiter for use with a liquid application system, said flow rate limiter including: a chamber having an inlet portion; an outlet portion; and flow restrictor provided across an interface between said inlet portion and the chamber.

In one embodiment, said flow restrictor comprises a blocking member, located at the interface between said inlet portion and said chamber, and movable between open and closed positions; and biasing member, biasing said blocking member to a closed position.

Specific embodiments of the invention will now be described with reference to the accompanying drawings.

### BRIEF DESCRIPTION OF THE DRAWINGS

FIGS. 1a, 1b and 1c illustrate a raised bed in accordance with one embodiment of the invention;

FIG. 2 illustrates an alternative form of bed in accordance with the invention;

FIG. 3 illustrates a pump tube in accordance with one embodiment of the invention;

FIG. 4 illustrates a schematic diagram of the system in accordance with another embodiment of the invention;

FIG. 5 illustrates a schematic diagram for an irrigation system in accordance with an embodiment of the present invention; and

FIGS. 6a and 6b illustrate a flow rate limiter in accordance with an embodiment of the present invention.

### DESCRIPTION OF THE ILLUSTRATED EMBODIMENTS

The body of matter onto which the liquid is to be dispensed by the system in accordance with the invention can take many forms. An example of one type is now shown for the purposes of illustration of the invention. In this case the body of matter is in the form of a raised bed which is a well established form for use in growing plants because they offer many advantages over growing plants in the ground. A raised bed in accordance with one embodiment of the invention is shown in figures la-c and comprises a body of matter in the form of soil 2 which is held in position via frame 4. The top surface 6 is exposed to sun and rain although, in one embodiment, a cloche can be positioned over the same to improve or increase growing. In this embodiment, underneath the body of matter such as soil and/or compost is a reservoir 7 in which liquid such as rainwater is held. The reservoir is lined by waterproof membrane 10 and the soil is separated from the reservoir via a liquid permeable lining 8. Thus, liquid which falls onto the soil or comes into the soil from the outer surface of the cloche or furthermore has previously been applied by the system, passes through the body of soil, through the permeable membrane and into the reservoir. Alternatively liquid from rainwater run-off, perhaps from a roof, may be used to fill the reservoir via a rain-saver device.

At least one reservoir tube or portion 12 is provided which passes from the reservoir to an entrance 14.

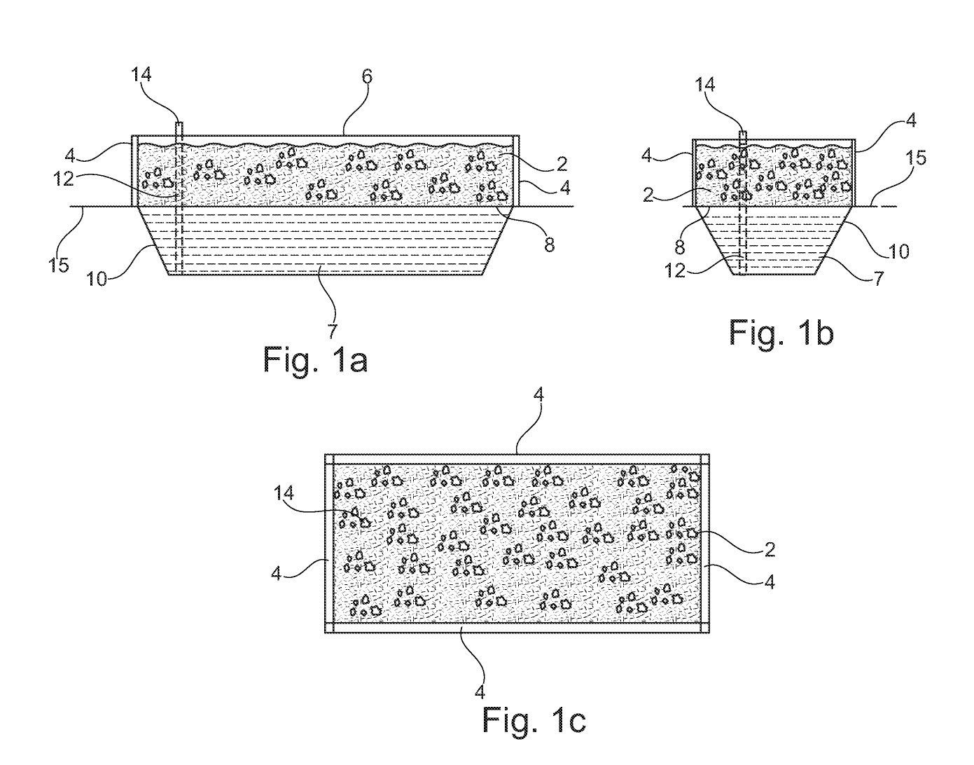

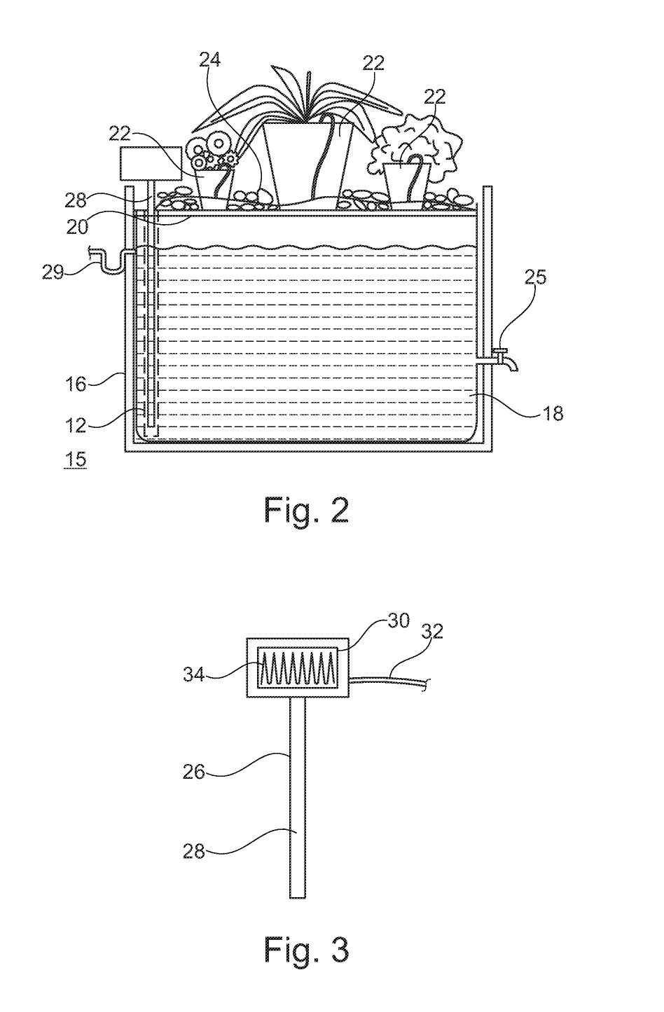

The location of the reservoir may be underground as shown in FIGS. 1a-c. This reservoir may extend to a single body of matter such as a raised bed, or may extend beneath several. Alternatively, it may be above ground level as is shown in FIG. 2 in which in this case, there is provided a butt 16 with the lower part being the reservoir 18 which receives liquid from for example a liquid saving device 29. A support shelf 20 separates the reservoir 18 from the bodies of soil in the plant pots 22 and other media 24 which is provided on top the support shelf. In this case, there is again provided the reservoir tube 12 to take liquid from the reservoir but furthermore, there is provided other means in the form of a tap 25 which allow liquid to be taken from the reservoir for other purposes.

FIG. 3 illustrates a pump tube 26 in accordance with one embodiment of the invention which comprises a tube portion 28 which is provided to be received in the reservoir tube 12 as shown in FIG. 2. Also provided in the pump tube 26, is a submersible pump (not shown), located typically at the entry into the tube and hence in the liquid of the reservoir and connected to pump liquid from the reservoir to housing 30 and then onwards to an exit 32 to which, for example, an irrigation system (not shown) can be connected to thereby apply liquid onto the body of soil at the required locations. Also provided on the housing, is a solar panel 34 provided to take energy from the sun or generally light conditions and to charge a power source provided within the housing 30 which in turn, when there is sufficient power and voltage in the power sources, causes the operation of the pump.

It will therefore be appreciated that the pump tube can be selectively positioned in any of the reservoir tubes 12 which are provided at a particular location or alternatively, one pump tube can be provided for each reservoir tube.

Typically the housing 30 will be provided with a controller to at least allow the system to be switched on and off. However the controller may also be provided to allow a timer facility for operation of the system and/or monitoring of the level of available power from the power supply.

Typically the batteries in the housing are used to regulate the voltage from the solar panel to a voltage suitable for the pump. The batteries are also used to accumulate energy from the solar panel and deliver power to the pump as required to control the volume of watering. In one embodiment alternative or additional power sources may be utilised.

In one embodiment a float is located in the pump tube and when the liquid level is sufficiently high in the tube, the float rises and activates a microswitch situated in the control box. The movement of the float is conveyed to the microswitch via a plastic cable, which runs along the centre of the tube. Typically the microswitch is provided to only allow the pump and solar panel to operate when there is sufficient liquid available.

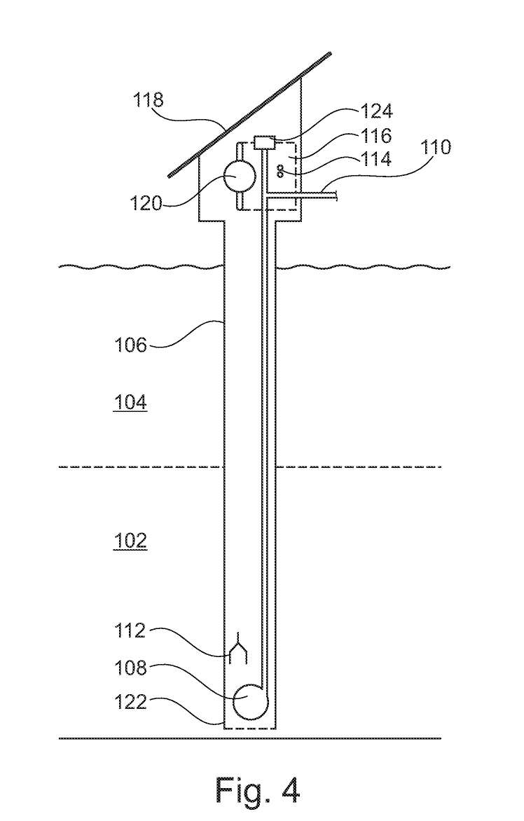

Referring to FIG. 4 there is shown a system in accordance with another embodiment of the invention, said system including a liquid reservoir 102 positioned below a body of soil 104 in which plants can be grown. The reservoir is connected to the area above the soil by a pipe 106 which is connected to a pump 108. The pump is provided to be operated to draw liquid from the reservoir and upwards along the pipe to a liquid application irrigator 110 which allows the liquid from the reservoir to be dispensed onto the body of soil 104 to water the same.

In accordance with this embodiment there is provided at least one sensor 112 in the pipe. The sensor is provided to detect levels of electrical current and is connected to an electrical control circuit. When the sensor is within the liquid in the pipe, i.e. liquid is present, the current which is sensed is different to that when the sensor is not in the liquid. The difference can be used to provide a means of switching the pump off when no liquid is present and on when the liquid is detected.

The sensor can also be used, or another sensor can be provided, to detect the condition of the liquid. For example, in one embodiment, the sensor can detect the presence of fertilizer in the liquid and the percentage present. This reading can in turn be indicated, via a visual indication 114, to the user of the system, who can decide whether or not to add fertilizer to the liquid. The visual indication can also be used to indicate the status of the pump and/or overall system.

The pump is typically powered via batteries 116 which are charged via solar panel 118. There is provided between the solar panel 118 and batteries 116, a potentiometer 120, which can be adjusted by the user to alter the extent to which the energy from the solar panel is used to charge the batteries. The detected or available degree of charge of the batteries can in turn be used to control the operation of the pump, in terms of the length of time of operation, i.e the less charge then the less operating time of the pump and less liquid application which will occur. Thus the potential uses of the system can be increased due to the ability to control the usage of the pump. In certain uses it can be useful to provide an anti-siphoning device 124 as part of the device, as shown in the Figure.

An inlet filter cap 122 can also be provided to prevent the ingress of foreign matter into the downpipe 106 and hence prevent the potential blockage of the pump or irrigation system.

In a further embodiment of the invention, not shown, the pump can be connected to the reservoir, such as a water butt, by a portion such as a tube or pipe. A filter body is typically fitted to the end of this tube and also acts as a weight to hold it in the liquid in the reservoir. The tube can be connected to the pump by suitable connectors such as by push-fit rubber or elastomer connectors. Similar push fit connectors can be used to connect the dispenser, such as an irrigation tube, which can lead to a dispersal system such as a drip irrigation system.

The pump employed can be of a positive displacement type in any of the embodiments. This means that the apparatus is capable of raising liquid to a relatively high level above the reservoir such as for example, high enough to irrigate a body of matter such as hanging baskets mounted at a height, such as up to 3 metres, above the reservoir. It also means that where the irrigator is lower than the liquid source, siphoning is prevented.

The controller housing can be fitted with a water-proof jack plug to allow connection to an optional remotely positioned solar panel for use remotely from the housing when the positioning of the pump is, by necessity, in shade.

The housing may be fixed to the side of the reservoir, or to a pipe, or a nearby support using an optional bracket. The bracket is designed to take a small padlock to secure the unit. While the pump is in position it is impossible to reach the fixings holding the bracket.

In a further embodiment a smaller solar panel, sized to provide the optimum power for its purpose, is employed, rather than using a potentiometer to reduce charging of the batteries.

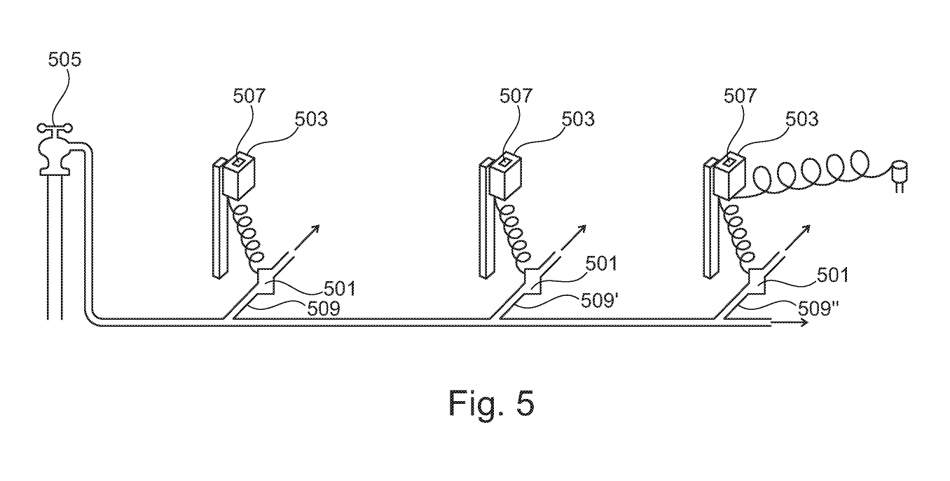

In other embodiments of the current system, a solenoid valve 501 may be provided in communication with the controller 503 and/or the power supply, and which is depicted, in one example, in FIG. 5. The solenoid 501 is provided as a means to permit or prohibit the flow of liquid from the reservoir on to the plant pots 22 or other media 24. The controller 503 will generally control the operation of the solenoid 501, for example between open (permitting the flow of liquid) and closed (prohibiting the flow of liquid) positions, but such operation may be determined by a number of external factors, such as light levels, water levels of the reservoir 18 in the butt 16, or the moisture levels in the soil/matter in which the various plants and other media are located. The solenoid valve 501 may be provided in the system as an alternative to the provision of the pump previously discussed, and the controller 503 therefore activate or deactivate the solenoid 501, rather than being responsible for switching on and off of the pump. It will therefore be envisaged that some examples of the invention will not require such a pump, for example, those where the supply system is provided in the form of a direct connection to a mains water supply, for example, via tap 505 shown in FIG. 5. In circumstances where the butt 16 and reservoir 18 are required, the pump may still be provided and work in unison with the provided solenoid 501.

Various sensors can be provided with the system of the present invention, and which may be provided according to the user's requirements. In particular, sensors provided detect a change in condition of any or any combination of the following: water level of the reservoir; moisture content of the body of matter; and/or levels of sunlight available can be provided as forming part of the present invention, and the detection of such changes in conditions may then be relayed to the controller, which will subsequently activate or deactivate the pump and/or the solenoid valve, depending on which is provided, thereby permitting or prohibiting the flow of liquid. This is highly advantageous as it allows the system to respond as is required by the external and environmental conditions, as opposed to being restricted to operation based on a rudimentary timer system.

A water level sensor can be provided to detect when water levels in the reservoir 18 drop below a predetermined level. When this occurs, a signal is subsequently sent to the controller, which will then either deactivate the pump or, where provided, it will result in closure of the solenoid, thereby preventing any further flow of water. The water level sensor can be adjusted within the reservoir 18 by a user, thereby allowing the user to determine the lower limit of the water level before the solenoid is activated. A further feature of the sensor is that when the water level does drop below the predetermined level, a warning or notification may be emitted to highlight to the user that the water level has dropped, and needs to be refilled. Such a warning or notification will preferably be provided as an audible warning. However, in other examples it is envisaged that a visual notification or a data notification, sent from the system to a user's mobile device may also be provided.

A moisture sensor may also be provided, and which is located in the soil or other matter that is to be watered. The levels of moisture may then be detected and predetermined levels may be set by the user, which will then subsequently allow the system to relay a signal, when the moisture drops bellows a particular level, to the controller 503, which in turn will open the solenoid valve 501 and allow the flow of water therethrough. Additionally, an upper level of moisture may be set, at which point when this level is reached, another signal can be sent to the controller 503, which results in the closure of the solenoid valve 501.

In addition to the provision of solar panel 34 above, which may be provided to take solar energy and charge the power supply, a light sensor 507 is also provided associated with the or each controller 503, which are provided so as to measure the specific levels of light. As light levels increase during the day, in accordance with the strength of the sun in the early/mid-afternoon, this will generally be the driest time of day and the time at which some plants require watering most. Therefore, predetermined light levels may be set on the sensor, above which a signal is sent to the controller 503 to moving the solenoid 501 to the open position and permit the flow of water. Similarly, users may wish to have a lengthy period of watering plants overnight. The light sensor 507 may equally be set with a level, below which These upper and lower light levels, as determined by a user, may be set together—between which the solenoid valve 501 remains closed—or individually, and when such a threshold is not met, the solenoid valve 501 will remain closed. This provides a user with an improved ability to determine how, when and under what circumstances their plants or other matter is watered, and is a vast improvement over a traditional timer system, or one provided with a rudimentary solar panel arrangement. Greater flexibility may also be provided, as shown in FIG. 5, if the irrigation system is provided with a number of branches 509, 509′, 509″. Thus, each branch may be tailored by the user with settings specific to the plants and other media that are to be watered by that branch, enabling different plants, with different watering requirements, to be treated in the most optimal manner. Of course, simpler systems may be provided wherein on one branch/controller 503 and set of sensors is required. Equally, where a solenoid valve 501 is not present and the pump is used, the same sensors as described above may be used in the same way, which ultimately determine, via the controller 503, whether or not the pump, and therefore the flow of liquid, is activated or deactivated.

There is therefore provided a system which can be utilised to save liquid and store the same for subsequent use as required. Furthermore the user of the system can be confident that the liquid will be applied when it is required with respect to the weather or environmental conditions at that time. This is due to the fact that the system can be more likely to, or be controlled to, operate in dry weather as a result of the greater level of recharging of the power sources which is possible at that time as a result of the light conditions being more favourable such as when the sun is shining. This, in turn, means that when power is available from the recharged batteries the system is capable of operating to pump liquid from the reservoir and through the system to be dispensed. Alternatively, when the light conditions are relatively poor, such as when it is cloudy, the power sources will not be as readily recharged and the system is less likely to be able to operate. However as, when it is cloudy it is more likely to have rained, there is less need for the system to be operated to dispense liquid. It should also be noted that additional or alternative power sources can be provided to allow the system to still be operated even when the environmental conditions are not favourable to allow recharging, thereby allowing dry but relatively poor light environmental conditions to be dealt with by still allowing watering to occur via operation of the system.

It should also be noted that the reference to a liquid reservoir throughout the description should be interpreted as any source of the liquid and may include a body of water which is stored in a tank or butt or a pond or may be a mains supply of water to which the system is connected.

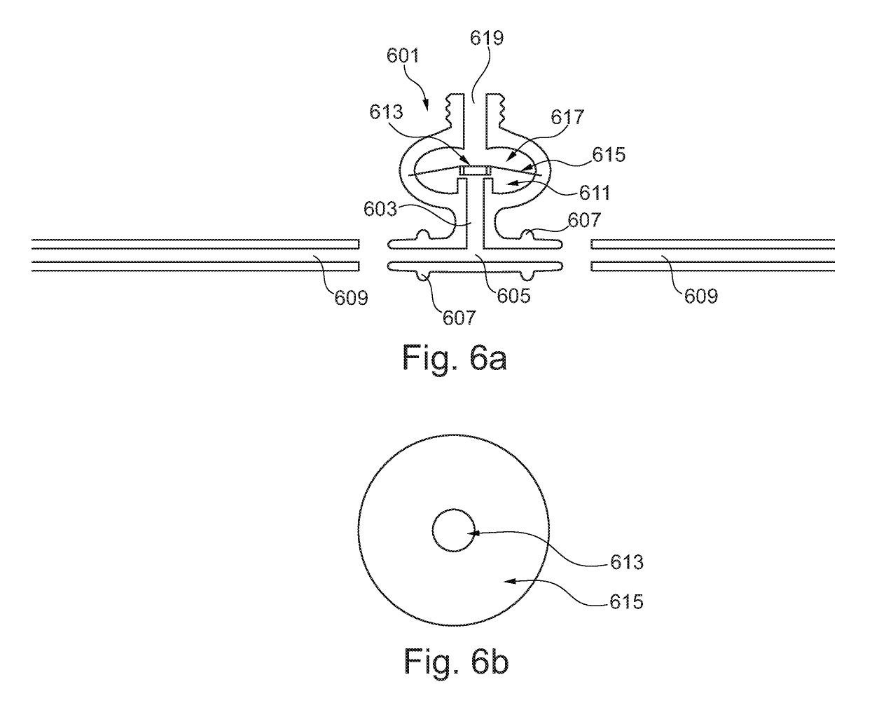

Referring now to FIG. 6, a further feature of the present invention is depicted and described below. As mentioned above, there is a need to provide a means by which to ensure even coverage of watering of plants, in particular, provided at varying heights from one another. Thus, the present invention provides an apparatus for limiting the flow rate of the liquid, in the form of dripper 601. The dripper 601 may be provided as part of the existing system—either as a connectable portion or formed integrally with the tube members—or provided as a separate apparatus for retro fitting to such systems. The dripper 601 includes an inlet port 603, which links the dripper 601 with a connecting portion 605 in the form of a T-junction. This allows the dripper 601 to be connected to and forming part of a larger irrigation system. Each end of the connecting portion 605 is provided with a bead or rib member 607, enabling it to connect securely to adjacent tube members 609 of the irrigation system. In some examples, there may be no need for such a connecting portion 605 as it is envisaged that the dripper 601 or a number of drippers may be formed integrally with a length of tube member for an irrigation system. In other examples, which may be used in addition to the above form, the dripper 601 may be provided as an end portion of a tube member 609, having a single connecting portion and bead or rib member 607, as opposed to the exemplified T-junction arrangement.

At the opposing end of the inlet portion 603, where the body of the dripper 601 is formed, the inlet portion 603 leads to an inlet chamber 611, the path to which is restricted by the presence of a flow restrictor in the form of blocking member 613, located over the aperture of the inlet portion 603, and a biasing membrane 615, which is provided to biasing the blocking member 613 to a closed position, blocking the aperture of the inlet portion 603. The membrane 615 and the blocking member 613 form a partition between the inlet chamber 611 and an outlet chamber 617. Initially, liquid may flow through the tube members 609 and branch into the dripper 601 via the inlet portion 603. The liquid will initially be met with resistance to entry into the inlet chamber 611 by the blocking member 613, however, as liquid pressure builds up, this overcomes the biasing force of the membrane 615, pushing back the blocking member 613 and entering the inlet chamber 611. The membrane 615 is provided to be formed from a permeable material, such as a microporous material, which therefore enables liquid, once it has entered the inlet chamber 611, to permeate through the membrane 615 and into the outlet chamber 617. Ultimately, upon filling the outlet chamber 617, liquid eventually exits from the dripper 601 via the outlet port 619 and into the soil, plants and other media in which the dripper 601 is located.

The blocking member 613 is formed from a substantially impermeable material and, as such, when the same is located over the inlet port 603, the movement of liquid or gas in either direction is prevented. However, and as discussed above, liquid may enter the inlet chamber 611 after a build-up in liquid pressure becomes sufficient to overcome the biasing force of the membrane 615 and move the blocking member 613 to an “open” position away from the inlet port 603. When the flow of liquid through the tube members 609 is reduced or stopped, the pressure on the biasing membrane 615 is consequently reduced, therefore allowing the blocking member 613 to move back to a “closed” position, covering the inlet port 603. This movement of the blocking member 613 back to the “closed” position is further encouraged by the weight of the liquid that remains in the outlet chamber 617, which may act in addition to the biasing nature of the membrane 615. When in this position, and because the blocking member 613 is formed from an impermeable material, liquid and gas alike are prevented from travelling back from the inlet chamber 611 through the inlet port 603 and into the tube members 609. Instead, the liquid remains in the chambers of the dripper 601 and prevents liquid from receding back through the tube members 609, thereby acting as a one-way valve. The dual use of the membrane 615 in controlling not only the flow of liquid therethrough, but also the position of the blocking member 613 is a unique combination and provides for a greatly improved dripper over those which are presently available. When the supply of liquid in the system is subsequently increased or turned back on, there is no delay in liquid reaching and being distributed from the dripper 601, regardless of the height at which it may be located or how far from the supply system in the irrigation system it is located, thereby providing a distinct advantage over the prior art.

1. A liquid application system for plants and the like, said system comprising a power supply, a controller, a supply system and a tube member, wherein said tube member is placeable into or connectable to a liquid reservoir to allow liquid from the liquid reservoir to be supplied therefrom to said plants and the like.

2. A system according to claim 1, wherein the system further includes a solenoid valve in communication with said controller and/or power supply.

3. A system according to claim 2, wherein said solenoid valve is located at an interface or connection between said controller and said supply system, and is arranged to permit or prohibit flow of liquid through the tube member.

4. A system according to claim 2, wherein the supply system is arranged to provide a natural flow of liquid from a mains-connected source of the liquid and the solenoid valve is arranged to permit or prohibit flow of liquid therethrough.

5. A system according to claim 2, wherein the supply system includes at least one pump arranged to pump liquid from the liquid reservoir onto a body of matter in which the plants and the like are located.

6. A system according to claim 2, wherein the controller controls operation of the solenoid valve.

7. A system according to claim 6, wherein the controller controls operation of the solenoid valve between an open position, permitting the flow of liquid therethrough, and a closed position, prohibiting flow of liquid.

8. A system according to claim 1, wherein a sensor is in communication with said controller.

9. A system according to claim 8, wherein said sensor is arranged to detect a change in one or more conditions associated with the system or a surrounding environment.

10. A system according to claim 9, wherein said sensor is arranged to detect a change in condition of any or any combination of the following: water level of the liquid reservoir; moisture content of a body of matter in which the plants and the like are located; and/or levels of sunlight available.

11. A system according to claim 10, wherein the detection of such conditions or changes in such conditions are relayed to the controller, which subsequently activates or deactivates a solenoid valve, permitting or prohibiting flow of liquid.

12. A system according to claim 1, wherein a water level sensor is in communication with said controller, and located within the liquid reservoir.

13. A system according to claim 12, wherein if the liquid within the liquid reservoir falls below a predetermined level, the water level sensor is arranged to send a signal to the controller to close a solenoid valve, preventing any further flow of liquid.

14. A system according to claim 1, wherein a moisture sensor is in communication with said controller and measures moisture content of a body of matter in which the plants and the like are located.

15. A system according to claim 14, wherein if the moisture content of the body of matter falls below a predetermined level, the moisture sensor is arranged to send a signal to the controller to open a solenoid valve, permitting flow of liquid to the body of matter.

16. A system according to claim 14, wherein if the moisture content of the body of matter exceeds a predetermined level, the moisture sensor is arranged to send a signal to the controller to close a solenoid valve, preventing flow of liquid to the body of matter.

17. A system according to claim 1, wherein a light sensor is in communication with said controller and is arranged to sense sunlight to which it is being exposed.

18. A system according to claim 17, wherein if the light has an intensity above a predetermined level, the light sensor is arranged to send a signal to the controller to open a solenoid valve, permitting flow of liquid to a body of matter in which the plants and the like are located.

19. A system according to claim 17, wherein if the light has an intensity below a predetermined level, the light sensor is arranged to send a signal to the controller to open a solenoid valve, permitting flow of liquid to a body of matter in which the plants and the like are located.

20. A system according to claim 1, wherein said power supply includes, at least in part, one or more solar panels and is in communication with said controller.

21. A system according to claim 20 wherein, said one or more solar panels are used to charge one or more batteries which, in turn, supply electrical power to the controller and/or supply system.

22. A liquid application system, said system including a power supply having one or more solar panels, a controller, a liquid supply system, and a tube member placeable into or connectable to a liquid reservoir to allow liquid from the reservoir to be supplied therefrom, and wherein said one or more solar panels are arranged to charge one or more batteries which, in turn, supply electrical power to the controller and/or supply system, the activation of which are thus determined by the degree of charge provided by the one or more solar panels.

23. A liquid application system, said liquid application system including a reservoir in which liquid can be collected, a body of matter in which at least one plant can be planted to grow and supply system to allow liquid to be selectively removed from the reservoir to be applied to the body of matter, the application of liquid occurring with respect to the condition of a power supply connected to at least the supply system, and wherein the system further includes flow rate limiter, for restricting flow of liquid through the system and into the body of matter.

24. A system according to claim 23, wherein said flow rate limiter is connectable to, or formed integrally with, a tube member associated with the said supply system, and at least some of the liquid is supplied through the system to the body of matter via the flow rate limiter.

25. A system according to claim 23, wherein said flow rate limiter includes: a chamber having an inlet portion; an outlet portion; and a flow restrictor arranged across an interface between said inlet portion and the chamber.

26. A system according to claim 25, wherein said inlet portion includes a connecting member for connection with a tube member associated with the said supply system.

27. A system according to claim 26, wherein said connecting member is a T-shaped junction, allowing liquid to flow both into the inlet portion and to continue through the or further tube members.

28. A system according to claim 25, wherein said flow restrictor comprises a blocking member, located at the interface between said inlet portion and said chamber, and movable between open and closed positions; and a biasing member, biasing said blocking member to a closed position.

29. A system according to claim 28, wherein said blocking member is formed from an impermeable material.

30. A system according to claim 28, wherein said biasing member is formed from a permeable material.

31. A system according to claim 25, wherein said chamber comprises an inlet chamber and an outlet chamber.

32. A system according to claim 31, wherein upon build-up of liquid pressure through the inlet portion and at the interface, said blocking member is movable to an open position, allowing the flow of liquid into the inlet chamber.

33. A system according to claim 31, wherein said flow restrictor, comprising a blocking member and a biasing member, forms a partition between said inlet chamber and said outlet chamber.

34. A system according to claim 33, wherein liquid is provided to permeate through the biasing member from the inlet chamber into the outlet chamber and, consequently, out of the outlet of the flow rate limiter and into the body of matter.

35. A system according to claim 31, wherein upon a reduction of liquid pressure at the interface, said blocking member is movable to the closed position, preventing the flow of liquid and/or gas from the outlet chamber through the inlet portion.

36. Flow rate limiter for use with a liquid application system, said flow rate limiter including: a chamber having an inlet portion; an outlet portion; and flow restrictor arranged across an interface between said inlet portion and the chamber.

37. A system according to claim 36, wherein said flow restrictor comprises a blocking member, located at the interface between said inlet portion and said chamber, and movable between open and closed positions; and a biasing member, biasing said blocking member to a closed position.
